(19) United States
(12) Patent Application Publication
(10) Pub. No.: US 2021/0140169 A1
(43) Pub. Date: May 13, 2021

(54) SELF-FORMING WEAVING STRUCTURE SYSTEM FOR CONSTRUCTION OF SPATIAL CURVED SURFACE BY ELASTIC ROD, AND CONSTRUCTION METHOD THEREOF

(71) Applicant: Tsinghua University, Beijing (CN)

(72) Inventors: Weixin Huang, Beijing (CN); Chenglin Wu, Beijing (CN); Jiankun Huang, Beijing (CN); Zhijia Chen, Beijing (CN)

(21) Appl. No.: 17/156,621

(22) Filed: Jan. 24, 2021

Related U.S. Application Data
(63) Continuation of application No. PCT/CN2019/097015, filed on Jul. 22, 2019.

(30) Foreign Application Priority Data
Jul. 24, 2018 (CN) 201810820278.1

(51) Int. Cl. E04B 1/32; F21V 23/00; F21S 4/22; F21V 33/00; G06F 30/10; G06F 30/30

(52) U.S. Cl. CPC E04B 1/3211; F21V 23/003; F21S 4/22; F21Y 2115/10; G06F 30/10; G06F 30/30; E04B 2001/3247; F21V 33/006

(57) ABSTRACT

The present disclosure relates to a self-forming weaving structure system by elastic rod for construction of spatial curved surface and a construction method thereof, the structural system includes a gridshell structure of a spatial curved surface, the gridshell structure includes a group of elastic rods, the elastic rods form a self-forming gridshell structure by bending the rods, and connecting each designated connection point on the rods to form a hinged joint or a rigid joint.

### CROSS-REFERENCE TO RELATED APPLICATION

This application is a continuation of International Application No. PCT/CN2019/097015, filed on Jul. 22, 2019, which claims priority to Chinese Patent Application No. 201810820278.1, filed on Jul. 24, 2018. All of the aforementioned patent applications are hereby incorporated by reference in their entireties.

### TECHNIC FILED

The present disclosure relates to a spatial curved surface structural system, espcially to a complex spatial curved surface by interwoven continuous elastic rods and a construction method thereof.

### BACKGROUND

Existing spatial curved surface structural systems and construction methods generally include:

I. Spatial mesh shell structure: linear structural members are connected according to certain rules to form shell structure, force such as tension, compression, or shear force are transmitted at the joints.

II. Frame structure: processing prefabricated members, and connecting the members to form a spatial curved surface.

III. Tensioned membrane structure: constituting a structural system with supporting rods and cables jointly with the tensile membrane itself.

IV. Steel or concrete shell structure: building a wooden mould according to spatial positioning information, and then cutting, assembling steel plates or casting concrete according to the shape of the wooden mould.

These curved surface structural systems and construction methods have the following problems in the construction process of complex spatial curved surface structural systems:

I. Tensioned membrane structure cannot be applied to the construction of complex spatial curved surface due to the limitation of its own material properties. The types of curved surfaces that can be constructed are limited, and the requirement of the mechanical properties of materials are high, while precise spatial positioning operation is difficult, which often requires high-altitude operations, thus the construction process is complex.

II. In the process of building complex curved surfaces, the spatial mesh shell structures and gridshell structures need accurate and large amount of three-dimensional spatial positioning works, and the numerical controlled fabrication of joints in advance according to the curved surface morphology. The construction process is complicated, which requires high construction accuracy when assembled on-site and needs to design cumbersome supporting structures, thus taking up a lot of functional space, affecting the aesthetics of buildings. Both material cost and labor cost are high.

III. In the process of constructing complex curved surfaces for the steel or concrete shell structure, it is necessary to prefabricate complex curved surface mould according to the curved surface morphology and build scaffold through three-dimensional positioning. After that, cut, assemble steel plates or cast concrete according to the morphology of wooden mould, which is time-consuming, low repeatability with high material waste. Especially for curved surfaces with a large degree of torsion, it is difficult to achieve with concrete structures etc. due to material limitations.

IV. If prefabricated members are adopted, many members will have different sizes due to the complexity of the structure, so each member needs to be prefabricated separately, which cannot be produced in a standardized way. The production time is long, the efficiency is low, the cost is high, the construction quality is difficult to guarantee, meanwhile the construction site conditions are complex and the construction environment is poor, which will result in installation error and member damage.

### SUMMARY

The purpose of the present disclosure is to provide a self-forming weaving structure system by elastic rod for construction of spatial curved surface and the construction method thereof to solve the problem in existing technical system for construction of spatial curved surface, including difficulty in material preprocessing and panel fabrication. It also solves the technical problem of on-site construction that the assembly and connection methods of members of complex curved surface require large quantity of complex and accurate spatial positioning works.

To achieve the above purposes, the present disclosure adopts the following technical solutions:

A self-forming weaving structure system by elastic rod for construction of spatial curved surface, including a gridshell structure of a spatial curved surface, the gridshell structure includes a group of continuous elastic rods, cross-sections of the elastic rods are circular or arc-shaped. The elastic rods form a self-forming gridshell structure by bending and interweaving the rods, and connecting each marked connection point on the rods to form a hinged connection or a rigid connection, where the elastic rods are structural members of the spatial gridshell structure and formation members of the spatial curved surface.

the elastic rod of the self-forming weaving structure system by elastic rod for construction of spatial curved surface includes a main frame. The main frame includes three different configurations: a single rod, a double rod assemblage or a multi-rod aggregation.

the single rod includes the first structural rod, where the first structural rod is tubular rod or sheet-like rod;

the double rod assemblage includes the inner second structural rod and the outer covering tube, where the second structural rod is tubular rod or solid rod;

the multi-rod aggregation is a large-section rod formed by bundling a group of small-section rods and by making the rods work cooperatively. The multi-rod aggregation includes a covering tube and a group of third structural rods, where the third structural rods are tubular rods or solid rods;

The first structural rod, the second structural rod, the covering tube and the third structural rods is made of FRP, PC, PE, PPR, carbon fiber, glass fiber or bamboo.

The elastic structural rod permits light to pass through and the elastic rod also includes a light-emitting device integrated to the rod. The light-emitting device includes a circuit controller and a light-emitting strip, where the light-emitting strip is attached to the main frame;

The light-emitting strip is one or more of a LED light strips, an optical fibers, or EL cold light wires.

The main frame is a single rod: the light-emitting strip is placed inside the single rod.

The main frame is a double rod assemblage:

The second structural rod is a transparent tubular rod. The light-emitting strip is placed inside the second structural rod.

The second structural rod is a solid rod. The light-emitting strip is attached to and fixed on one side of the second structural rod.

The main frame is a multi-rod aggregation:

The third structural rod is a solid rod, The light-emitting strip is placed inside a covering tube.

The connection joint is a binding connection with a binding strip, a stud connection, or a joint with a 3D printing connection, where the binding strip is a cotton rope, a nylon strip or a metal strip. The 3D printed integrated joint is a plastic joint or a metal joint.

The self-forming weaving structure system by elastic rod for construction of spatial curved surface also includes an enclosure structure connected to the gridshell structure, where the enclosure structure is covered at least a grid of the gridshell structure and is consistent with the curved surface form at the grid. The enclosure structure is fixed onto the gridshell structure through covering, braiding or customized panel system.

The enclosure structure is a single-layer membrane or a composite membrane, the single-layer membrane is a single-layer inflatable membrane. The inflatable composite membrane includes a single-layer membrane and a shell made of FRP attached on a surface of the single-layer membrane.

A construction method of the self-forming weaving structure system by elastic rod for construction of spatial curved surface, including the following steps:

Step 1, establishing a computer algorithm, generating a spatial curved surface using three-dimensional modeling software, then after importing the spatial curved surface into the program and setting parameters, automatically generating the model of the self-forming weaving structure system by elastic rod for construction of spatial curved surface, meanwhile generating a scheme for construction; then performing mechanical simulation on the structural model with material property parameters to obtain a stable form under various loads including gravity, axial force and bending moment, performing stress simulation on the structure in the program to observe its deformation under load conditions, then evaluating the construction scheme of the elastic rods.

Step 2, deriving the construction scheme after evaluating as qualified, where the construction organization scheme includes a length of each elastic rod and a joint positions on each elastic rod. Generating a numbering of each elastic rod and a numbering of the joint position according to the scheme; then, according to the numbering of the elastic rod, cutting the rod, marking the numbering of the corresponding joint at the joint position of the elastic rod, meanwhile determining the connection sequence of the elastic rods in the construction process according to an actual situation of the spatial form.

Step 3, processing the elastic rods: each elastic rod needs to be painted, cut, connected, and the joint position be marked.

Step 4, placing the elastic rods at corresponding positions one by one according to the numberings of the elastic rods, numberings of joints and the construction sequence; connecting the elastic rods at the joints position, gradually forming the spatial curved surface as the elastic rods are connected one by one. Once all the elastic rods are connected, the interwoven elastic rods reach a stress balance due to an interaction of the rods, eventually become a gridshell structure of the spatial curved surface.

The planning organization scheme in step 2 also includes a circuit design of a light-emitting device, where then in step 4, according to the circuit design, the light-emitting device is placed inside the main frame of the structure. The light-emitting device and the elastic rod are constructed simultaneously.

The light-emitting device includes a circuit controller and a light-emitting strip, where the light-emitting strip is connected to a transformer through a wire. The series connection and parallel connection of the light-emitting strips is controlled by the circuit controller to obtain different spatial lighting effects.

After step 4, attaching an enclosure structure onto the elastic rods to cover the gridshell structure. The algorithm program in step 1 includes a form generation algorithm and a stress analysis algorithm.

The form generation algorithm is as follows:

Firstly, taking the spatial curved surface generated by a three-dimensional modeling software as an original input; generating, by the program, a triangular mesh as uniform as possible on the spatial curved surface according to a given length of each edge of the spatial curved mesh surface after importing the spatial curved surface into the form generation program, where the mesh is an original mesh, then connecting midpoints of each edge of the original mesh to generate a new mesh. In the new mesh, only two rods are connected. There is no case that three or more rods intersecting, so as to reduce the construction difficulty. Optimizing and transforming the new mesh into continuous curves, generating tubular structure members along the continuous curves, where the tubular structure is the model of the self-forming weaving structure system by elastic rod for construction of spatial curved surface consistent with the original curved surface form. In the model, the information of the length of the rod and the connection point position are all correspond to the actual construction situation.

The stress analysis algorithm is as follows:

A basic stress unit is two thin rods connected by a hinge point; except a hinge point, the two thin rods are connected by a spring; in response that the spring is compressed, the two rods approach to each other, the angle between the two rods becomes smaller; in response that the spring is extended, the two rods move away from each other, the angle between the two rods becomes larger, so as to simulate elastic bending resistance of the rod. In response that the rod system is imported into a stress analysis program, the bending rod is divided into a set of rod units, each unit is connected sequentially to form a chain of elastic rods; inputting parameters of the spring in the stress analysis program according to the mechanical properties of material; adding external forces of the rod units and anchoring points of the rod units in the stress analysis program according to a structural design; performing calculation iteratively after all the spring parameters, the external forces of the rod units and the anchoring points of the rod units are set in the stress analysis program, that is, calculating, by the stress analysis algorithm, a final balance state that represents the structure in real situation is obtained by the stress analysis program.

Compared with the prior technologies, the present disclosure has the following characteristics and beneficial effects:

According to the present disclosure, materials with superior mechanical properties are adopted, and are applied to complex spatial curved surface structures with complex topology and various morphology, thus have solved the technical difficulty in material processing and the problem of low degree of realization of curved surface form in the existing system for construction of complex spatial curved surface. It also have solved the technical problem that the operation of spatial precise positioning is difficult, the high-altitude operations are complicated during the construction of complex curved surface form. The details are as follows:

### I. Light Weight of Structure

In the structural system of the present disclosure, elastic rods made of materials with superior mechanical properties are selected for the gridshell structure, the cross section of the structure member is optimized, at the same time, the design of connection points is simplified. The present disclosure adopts elastic materials, the whole structure is light in weight, the material transportation is convenient, the construction and movement of the structure are very simple and convenient.

### II. Reasonable Stress Distribution

When designing the structural scheme, the structural system of the present disclosure avoids excessive local stress of the structure, obtains a structural scheme with a relatively uniform grid distribution according to the algorithm. Meanwhile, because the stress and deformation of the elastic rods are consistent, after the curved surface gridshell structure is built according to the design scheme, the rods will be slightly deformed according to the stress condition. The overall form after deformation has little change. At the same time, because the rods are balanced in the structure, the overall stress is more uniform and reasonable. The rod connection is simple and clear with clear force transmission, forming a self-forming weaving structure system by elastic rod for construction of spatial curved surface.

Meanwhile, when elastic rods are adopted for construction, as the materials of rods are uniform along the axial direction, there are generally no torsion problems when forming complex spatial curved surface form. Therefore, when the curved surface form is constructed by bending the rods, no additional processing of the materials is necessary. It is only needed to connect the rods according to the joint information, thus simplifies the construction.

### III. Beautiful Appearance and Potential of Interactive Performance

When the design scheme is generated, the gridshell structure of the present disclosure has the characteristics of weaving; meanwhile, the gridshell structure is made of transparent or translucent elastic material, thus possessing the characteristics of simple and beautiful shape. Meanwhile, a light-emitting device can be added into the gridshell structure. The structural rods are combined with the light-emitting device to adjust the transparency and position of the surface envelope, to enable various lighting effect according to the control of the user, therefore change the overall space effect, thus obtaining an attractive visual effect.

### IV. Wide Range of Application

The present disclosure can be applied not only to the design and construction of artistic installations, but also to the design and construction of large enclosure structures, the design and production of smaller lamps, lanterns, etc. The outer side of the gridshell structure can be covered with the enclosure material to form the enclosure structure of the building. By using different rod materials, the present disclosure can be used for not only lamp design on a smaller scale, but also for building construction on a larger scale.

### V. Simple Construction

In the construction process of the present disclosure, the main work is the preparation of materials and the connection of joints. A new form generation algorithm is adopted, after analyzing any given complex surface, the corresponding interwoven gridshell structure model can be generated, a construction scheme can be formed for construction of a gridshell structure consistent with the original complex curved surface form. Meanwhile, the corresponding stress simulation program is developed for the construction system. After setting the material properties and other parameters, the internal force and deformation of the structure during the process of construction and after the completion of construction can be simulated to evaluate the rationality of the structural scheme, the construction scheme, etc.

At the same time, according to the analysis of the three-dimensional model of the structure, the intersection of each rod can be derived, so as to enable to mark the joint positioning on the rod in the preparation of construction; in the construction process, the construction of the whole structure can be completed step by step only by connecting the rods according to the joint positioning, and the positioning of three-dimensional space points is transformed into the positioning of points on one-dimensional rods and the interconnecting of corresponding positions of the rods. The construction process is simplified, the required time is reduced, the construction efficiency is improved, and the costs of mechanical, labor and material of the construction of complex spatial structures are greatly reduced, and therefore the present disclosure can be applied to construction of complex spatial forms.

When workers construct complex curved surface form, they only need to interconnect the rods according to the joint information, so that the spatial structure can be built gradually based on the elasticity of the material in the construction process. With the construction progress, the rods gradually form the designed morphology under mutual restraint, only simple supports are needed to assist positioning during construction, without requirement of precise and tedious spatial positioning, thus simplifying the construction complexity meanwhile easy to understand.

According to the designed topological scheme, the rods are interwoven and connected. The structure can be self-formed by utilizing the elasticity and mutual restraint of the rods, so that the structural morphology is natural and reasonable. As a new structural system, it has broad prospects in the future application in construction of complex curved surface form with different scales. Meanwhile, through digital geometry and mechanical simulation, the system can construct complex and diverse curved surface form, thus providing greater freedom for design.

The present disclosure provides a design and a construction method of a complex spatial structure, which utilizes elastic rods that are interwoven and connected with each other to form a spatial structural system. This system can not only construct curved surfaces with complex topology and various forms, but also optimize the design of the system through digital geometric morphology generation and mechanical simulation, thus providing greater freedom for design.

### BRIEF DESCRIPTION OF DRAWINGS

The present disclosure will be described in further detail with reference to the accompanying drawings.

FIG. 1 is a structural schematic diagram of a hemispherical gridshell structure according to the present disclosure.

FIG. 2 is a structural schematic diagram of a cross-section of a single rod according to an embodiment of the present disclosure.

FIG. 3 is a structural schematic diagram of a cross-section of a double rod assemblage according to an embodiment of the present disclosure.

FIG. 4 is another structural schematic diagram of a cross-section of a double rod assemblage according to an embodiment of the present disclosure.

FIG. 5 is a structural schematic diagram of a cross-section of a multi-rod aggregation according to an embodiment of the present disclosure.

FIG. 6 is a structural schematic diagram of a first joint connection between A in FIG. 1 and B in FIG. 10 according to the present disclosure.

FIG. 7 is a combined connection diagram of FIG. 6.

FIG. 8 is a structural schematic diagram of a second joint connection between A in FIG. 1 and B in FIG. 10 according to the present disclosure.

FIG. 9 is a structural schematic diagram of a third joint connection between A in FIG. 1 and B in FIG. 10 according to the present disclosure.

FIG. 10 is a schematic diagram of a hemispherical gridshell structure with an enclosure structure according to the present disclosure.

FIG. 11 is a schematic diagram of a gridshell structure of a tee joint form according to the present disclosure.

Reference numbering: 1—elastic rod, 2—single rod, 3—double rod assemblage, 4—multi-rod aggregation, 5—first structural rod, 6—second structural rod, 7—covering tube, 8—third structural rod, 9—light-emitting strip, 10—enclosure structure, 11—starting edge rod, 12—weaving inner rods, 13—joint splint, 14—stud hole, 15—connecting stud, 16—limit stud, 17—trough body, 18—wire, 19—end connection head, 20—connecting lug plate, 21—lug plate stud.

### DESCRIPTION OF EMBODIMENTS

Referring to FIG. 1, a spatial curved surface weaving structural system with a hemispherical form is designed. This structural system includes a gridshell structure of a spatial curved surface, the gridshell structure includes a group of continuous and elastic rods 1, the cross section of the elastic rods 1 is circular. The elastic rods 1 form a self-forming gridshell structure by bending the rods, interweaving the rods and connecting each connection point between the rods, where the connection point is a hinged connection or a rigid connection. The elastic rods 1 are configured as structural members of the gridshell structure and forming members of a spatial curved surface.

In the present disclosure, continuous elastic rods are used to form the structure, bending and pressing of the rods are the main stress state of the structure, which is an important feature of the weaving structure. As the elastic rods will twist in the structure, and to ensure that the rods have continuous and consistent bending resistance, the cross section of the rods should be selected as circular to construct the structure without prefabricating the torsion of the rods in advance.

The elastic rod includes a main frame, the mainframe includes three forms: a single rod 2, a double rod assemblage 3 or a multi-rod aggregation 4.

The main frame enables light to pass through. The elastic rod also includes a light-emitting device connected to the main frame integrally, the light-emitting device includes a circuit controller and a light-emitting strip, where the light-emitting strip is attached to the main frame and is fixed on at least one elastic rod. The main loads borne by the gridshell structure of the present disclosure are self-weight load, external loads and internal forces generated by bending of the rods, the loads are borne by the main frame of the structure, the light-emitting device bear no stress.

The light-emitting strip is one or more of a LED light strip, an optical fiber or an EL cold light wire. A small lighting device with a specific spatial form can be manufactured with optical fiber or EL cold light wire.

Referring to FIG. 2, when the main frame adopts a single rod 2, the single rod 2 includes a first structural rod 5, the first structural rod 5 is a tubular rod, it may also be a sheet-like rod in other embodiments. The light-emitting strip is placed inside the first structural rod. Referring to a cross-section of a single rod of FIG. 2, the first structural rod is made of a PC tube. The PC tube is configured as a structural rod, the light-emitting strip is a LED light strip. The LED light strip is placed inside the PC tube to form an integral rod.

When the main frame adopts the double rod assemblage 3, the double rod assemblage is an inner and outer double-layer nested double-layer rod, the double rod assemblage includes an inner second structural rod 6 and an outer covering tube 7.

Referring to FIG. 3, when the second structural rod is a tubular rod, the light-emitting strip 9 is placed inside the second structural rod 6. Referring to a cross-section of a double rod assemblage of FIG. 3, the second structural rod 6 is made of PE tube. The covering tube 7 is made of the PC tube. The PE tube is configured as a stressed rod, the light-emitting strip 9 is a LED light strip. The LED light strip is placed inside the PE tube, after that the LED light strip and PE tube are put into the PC tube to form an integral rod.

Referring to FIG. 4, when the second structural rod is a solid rod, the light-emitting strip 9 is attached and fixed on the side of the second structural rod 6. Referring to another cross-section of a double rod assemblage of FIG. 4, the second structural rod 6 is made of FRP solid rod. The covering tube 7 is made of PE tube. The FRP solid rod is configured as a structural rod, the light-emitting strip 9 is a LED light strip. The LED light strip is bonded and fixed on a side of FRP solid rod, then the LED light strip and FRP solid rod are placed in the PE tube to form an integral rod. In this situation, PE tube can be made white and translucent.

Referring to FIG. 5, when the main frame adopts multi-rod aggregation 4, the multi-rod aggregation is a group of small-section rods connected to form large-section rods by bundling and make them working cooperatively, the multi-rod aggregation 5 includes a covering tube 7 of an outer layer and a group of third structural rods 8, where the third structural rods 8 are solid rods. Multi-strands of rods with smaller cross-sections are combined, they are working cooperatively by bundling and other means to form a larger cross-section, to enable enhancing the overall mechanical properties of the structure. During construction, first, the small-section rod can be placed in position according to the curved surface form, and then can be stressed cooperatively by hoop, etc., which solves the construction problem that the large-section rod is difficult to move or bend. If the light-emitting strip is required, the covering tube with a larger size can be replaced, and then the light-emitting strip is attached to the third structural rod and is placed inside the covering tube.

Structure sizes range from small to large, rod materials can be used from several millimeters to several centimeters in diameter. Therefore, the first structural rod, the second structural rod, the covering tube and the third structural rod can be made of FRP, PC, PE, PPR, carbon fiber, glass fiber or bamboo. When FRP, PC, PE, PPR, carbon fiber and glass fiber are used, all materials are made as transparent or translucent rods.

The joint of the present disclosure is a binding connection with a binding strip, a stud connection or a joint connection with a 3D printing connection, where the binding strip is a cotton rope, a nylon strip or a metal strip, the 3D integrated printed joint connection is a plastic joint or a metal joint.

Referring to FIG. 1, FIG. 6 and FIG. 7, in this embodiment, the elastic rod of the hemispherical spatial curved surface weaving structural system includes starting edge rods 11 and weaving inner rods 12. The starting edge rod 11 is a circular elastic rods at the bottom of the weaving structure, the weaving inner rods 12 form a curved surface form of the weaving structure. The weaving inner rods 12 start weave from the starting edge rod 11 and end at the other side of the starting edge rod 11. The joint between the elastic rods of the weaving inner rods 12 are two-rod connections of two elastic rods, while the joint between the starting edge rod and the weaving inner rods are three-rod connections of two elastic rods of the weaving inner rods and one elastic rod of the starting edge rod.

At a connecting position of the two rods, the rods should be stacked up and down to connect, the two rods are not in the same plane at the joint. While at the joint of three-rod connections, the rods are in the same plane.

Referring to FIGS. 6-7, the joint of the three-rod connection in this embodiment adopts a single rod, and the first structural rod 5 of the single rod 2 is a tubular rod. This joint adopts stud connection with joint splints 13. No holes are drilled in the starting edge rod 11. Each weaving inner rod 12 is provided with a stud hole 14. The joint splints 13 are arranged opposite to each other up and down, three rods are clamped between the joint splints 13. Each joint splint is provided with six stud holes, two of which are configured to fix the weaving inner rods 12 through connecting bolts 15, the remaining four are configured to fix limit bolts 16, which are arranged in pairs and symmetrically on the joint splints 13. The setting width of each pair of limit bolts 16 is adapted to the size of the starting edge rod 11, and the starting edge rod 11 are placed between the limit bolts 16. The four limit bolts placed inside bolt holes on the two joint splints up and down, and the two connecting bolts penetrate the bolt holes on the two joint splints, but also into the bolt holes on the weaving inner rods.

Referring to FIG. 8, this embodiment is different from the joint in FIG. 7 in that the joint adopts a single rod, the first structural rod 5 of the single rod 2 is a sheet-like rod. Light-emitting strips 9 is placed inside the rods. In order to ensure the series-parallel connection of light-emitting strips, it is necessary to set trough body 17 at the position where the rods meet and at the side of the starting edge rod, after that cut off a small external covering layer at the position where the rods meet, to enable to locate the wires 18 inside the single rod and stuck the circuits of light-emitting strips within the trough body 17. One side of the joint splint 13 is used as a joint connection plate, the design position of the bolt is the same as that of the previous embodiment.

Referring to FIG. 9, this embodiment is different from the joints in FIG. 7 and FIG. 8 in that the joints adopt multi-rod aggregation 4, the third structural rod 8 is a sheet-like rod, no light-emitting strip is placed in the rod. This joint is a bolt connection with a joint connection plate.

The ends of the third structural rod 8 of the weaving inner rods are respectively provided with an end connection head 19. A part of end connection head is inserted into the covering tube and fixedly connected with the third structural rod 8, the other part of the end connection head extends out of the covering tube, and the end extending out of the covering tube is fixedly connected with a connecting lug plate 20 provided with a bolt hole, the connecting lug plate 20 is arranged along the direction of the structural rod; the rod at the intersection position of the rod in the starting edge rod 11 is divided into two sections, the end head of each section is provided with an end connection head 19, the two end connection heads 19 are butted as a whole. One side of the two end connection heads 19 is fixedly connected with a connecting lug plate 20 generally, which is arranged perpendicular to the direction of the structural rod and is correspondingly provided with two bolt holes. The connecting lug plate is stacked with the connecting lug plate 20 of the weaving rods and aligned with the bolt holes. The bolt holes of the two parts are connected by lug plate bolt 21. To ensure the connection between the connecting lug plate at the starting edge rod and the end connection head, it is necessary to slot the edge of the covering tube at the intersection of the rods.

Referring to FIG. 10, the self-forming weaving structure system by elastic rod for construction of spatial curved surface also includes an enclosure structure connected on the gridshell structure, where the enclosure structure is arranged at least a grid of the gridshell structure and is consistent with the curved surface form at the grid, the enclosure structure is fixed onto the gridshell structure through covering, braiding or customized panel system, so as to enable the gridshell structure and the enclosure structure to jointly form a building indoor space which can resist wind and rain, temperature change, sunlight, etc. Setting the enclosure structures at different grids produces different decorative effects.

The enclosure structure is a single-layer membrane or a composite membrane, the single-layer membrane is a single-layer inflatable membrane, the inflatable composite membrane includes a single-layer membrane and a shell made of FRP attached on a surface of the single-layer membrane.

According to the present disclosure, an arbitrary spatial curved surface shape can be formed by self-forming, for example, as shown in FIG. 11, a spatial curved surface weaving structural system with the outer shape of a tee joint form is designed. The elastic rod of this weaving structure includes a starting edge rod 11 and a weaving inner rods 12 during weaving. The starting edge rods 11 are three circles of elastic weaving rods, the weaving inner rods 12 jointly forms a curved surface form of the weaving structure. The weaving inner rod 12 starts weaving from a circle of the starting edge rod 11 and end at another circle of the starting edge rod 11. The joints between the elastic rods of the weaving inner rods 12 are two-rod connections of two elastic rods, while the joints between the starting edge rods 11 and the weaving inner rods 12 are three-rod connections of two elastic rods of the weaving inner rods 12 and one elastic rod of the starting edge rods 11.

The construction method of the self-forming weaving structure system by elastic rod for construction of spatial curved surface, includes the following construction steps:

step 1, establishing a computer algorithm, generating a spatial curved surface through three-dimensional modeling software, then after importing the spatial curved surface into the program and setting the parameters, automatically generating the model of the self-forming weaving structure system for construction of spatial curved surface by elastic rod, and generating a scheme for construction; then performing mechanical simulation on the structural model with material property parameters to obtain a stable form under various loads including gravity, axial force and bending moment, performing stress simulation on the structure in the program to observe its deformation under load conditions, and then evaluating the construction scheme of the elastic rods. Due to the large deformation of elastic rods, it is important to simulate the deformation process and results of the self-forming weaving structure system by elastic rod for construction of spatial curved surface by computer.

Step 2, deriving the construction scheme after evaluating as qualified, where the construction scheme includes a length of each elastic rod and joint positions on each elastic rod, generating the numbering of each elastic rod and a numbering of the joint position in the program according to the scheme; then, according to the length and the numbering of the elastic rod, cutting the rod, marking the numbering of the corresponding joint at the joint position of the elastic rod, determining the connection sequence of the elastic rods in the construction process according to an actual situation of the spatial form.

Step 3, processing the elastic rods: each elastic rod needs to be painted, cut, connected and the joint position be marked a numbering. If the length of the rod is insufficient, the metal assemblage is used for extension connection.

Step 4, sequentially placing the elastic rods at corresponding positions one by one according to the numberings of the elastic rods, numberings of joints and the construction sequence, connecting the elastic rods at the joint positions by the joints, and gradually forming the spatial curved surface as the elastic rods are connected together one by one; as all the elastic rods are connected, the interwoven elastic rods reach a stress balance due to an interaction of the rods and become the gridshell structure of the spatial curved surface.

The construction scheme in step 2 also includes a circuit design of a light-emitting device, where then in step 4, according to the circuit design, the light-emitting device is placed inside the rods or attached to the rods of the structure, and construction of the light-emitting device and the elastic rod are carried out together;

the light-emitting device includes a circuit controller and a light-emitting strip, where the light-emitting strip is connected to a transformer through wires, and the circuit controller send control signal to a series or in-line circuit of the light-emitting strips to perform different spatial lighting effects.

After step 4, attaching an enclosure structure onto the elastic rods as the enclosure of the inner space.

The computer algorithm in step 1 includes a form generation algorithm and a stress analysis algorithm;

the form generation algorithm is as follows:

firstly, taking the spatial curved surface generated by the three-dimensional modeling software as an original input; generating, by the algorithm, a triangular mesh grid as uniform as possible on the spatial curved surface according to a designated length of mesh edges. Taking the uniform triangular mesh grid as an original grid, generate a new grid through connecting midpoints of each edge of the original grid; in the new grid, all joints are joints with two intersecting rods, there are no intersecting joints of three or more rods, so the construction difficulty are reduced; optimizing and transforming the new grid into continuous curves, generating tubular members along the continuous curves, where the tubular members represent the elastic rods of the self-forming weaving structure model, which is consistent with the original curved surface form; in the model, the information of the rod length and the joint position are all correspond to the actual construction situation;

the structural analysis algorithm is as follows:

a basic structural simulation unit is two thin rods connected by a hinge joint; the hinge joint are integrated with a spring for bending resistance; in response that the spring is compressed, the two rods approach to each other, and the angle between the two rods becomes smaller; in response that the spring is extended, the two rods move away from each other and the angle between the two rods becomes larger, so as to simulate elastic bending resistance of the rod; in the structural simulation program, the bending rod is divided into a set of rod units, and the units are connected sequentially to form a chain of bending resisting elastic rods; setting parameters of the spring in the structural analysis program according to the mechanical properties of the material; adding external forces and anchor points of the rod units in the structural analysis program according to the structural design; performing iterative simulation and a final balanced state is achieved, which represents the situation of the structure in real situation.

We claim:

1. A self-forming weaving structure system by elastic rod for construction of spatial curved surface, characterized by including a structure of a spatial curved surface, the structure includes a group of continuous and bendable elastic rods (1), cross-sections of the elastic rods are circular or arc-shaped, and the elastic rods (1) form a self-forming gridshell structure by bending and interweaving the rods and connecting each marked connection point on the rods, wherein the connection point is a hinged connection or a rigid connection, the elastic rods are structural members of the spatial gridshell structure and formation members of the spatial curved surface.

2. The self-forming weaving structure system by elastic rod for construction of spatial curved surface according to claim 1, characterized in that the elastic rod includes a main frame, and the main frame includes three different configurations: a single rod (2), a double rod assemblage (3) or a multi-rod aggregation (4);
the single rod (2) includes the first structural rod (5), wherein the first structural rod (5) is tubular rod or sheet-like rod;
the double rod assemblage (3) includes an inner second structural rod (6) and an outer covering tube (7), wherein the second structural rod (6) is tubular rod or solid rod;
the multi-rod aggregation (4) is a large-section rod formed by bundling a group of small-section rods and making the rods work cooperatively, the multi-rod aggregation includes a covering tube (7) of an outer layer and a group of third structural rods (8), wherein the third structural rods (8) are tubular rods or solid rods;
wherein the first structural rod (5), the second structural rod (6), the covering tube (7) and the third structural rods (8) are made of FRP, PC, PE, PPR, carbon fiber, glass fiber or bamboo.

3. The self-forming weaving structure system by elastic rod for construction of spatial curved surface according to claim 2, characterized in that the main frame enables light to pass through, the elastic rod (1) further includes a light-emitting device connected to the main frame integrally, and the light-emitting device includes a circuit controller and a light-emitting strip (9), wherein the light-emitting strip (9) is attached to the main frame and is fixed on at least one elastic rod;
wherein the light-emitting strip is one or more of a LED light strip, an optical fiber, or an EL cold light wire.

4. The self-forming weaving structure system by elastic rod for construction of spatial curved surface according to claim 3, characterized in that:
the main frame is the single rod (2): the light-emitting strip (9) is placed inside the first structural rod (5);
the main frame is the double rod assemblage (3):
the second structural rod (6) is a tubular rod, and the light-emitting strip (9) is placed inside the second structural rod (6),
the second structural rod (6) is a solid rod, and the light-emitting strip (9) is attached to and fixed on one side of the second structural rod (6),
the main frame is the multi-rod aggregation (4):
the third structural rod (8) is a solid rod, and the light-emitting strip (9) is placed inside the covering tube (7).

5. The self-forming weaving structure system by elastic rod for construction of spatial curved surface according to claim 1, characterized in that the connection joint is a binding connection with a binding strip, a stud connection or a joint with a 3D printing connection, wherein the binding strip is a cotton rope, a nylon strip or a metal strip, and the 3D integrated printed joint is a plastic joint or a metal joint.

6. The self-forming weaving structure system by elastic rod for construction of spatial curved surface according to claim 5, characterized in that the self-forming weaving structure system by elastic rod for construction of spatial curved surface further includes an enclosure structure (10) connected to the gridshell structure, wherein the enclosure structure (10) is covered at least a grid of the gridshell structure and is consistent with the curved surface form at the grid, and the enclosure structure (10) is fixed onto the gridshell structure through covering, braiding or customized panel system.

7. The self-forming weaving structure system by elastic rod for construction of spatial curved surface according to claim 6, characterized in that the enclosure structure (10) is a single-layer membrane or a composite membrane, the single-layer membrane is a single-layer inflatable membrane, and the inflatable composite membrane includes a single-layer membrane and a shell made of FRP attached on a surface of the single-layer membrane.

8. A construction method of the self-forming weaving structure system by elastic rod for construction of spatial curved surface according to claim 1, characterized in that construction steps are as follows:
step 1, establishing a computer algorithm, generating a spatial curved surface using three-dimensional modeling software, then after importing the spatial curved surface into the program and setting parameters, automatically generating the model of the self-forming weaving structure system by elastic rod for construction of spatial curved surface, and generating a scheme for construction, then performing mechanical simulation on the structural model with material property parameters to obtain a stable form under various loads including gravity, axial force and bending moment, performing stress simulation on the structure in the program to observe its deformation after stressing, and then evaluating the construction scheme of the elastic rods;
step 2, deriving the construction scheme after evaluating as qualified, wherein the construction scheme includes a length of each elastic rod and joint positions on each elastic rod, and generating the length of the elastic rod, a numbering of each elastic rod and a numbering of the joint position in the program according to the scheme; then, according to the length and the numbering of the elastic rod, cutting the rod, marking the numbering of the corresponding connection point on the joint position of the elastic rod, and determining the connection sequence of the elastic rods in the construction process according to an actual situation of the spatial form;
step 3, processing the elastic rods: each elastic rod needs to be painted, cut, connected and the joint position be marked a numbering;
step 4, placing the elastic rods at corresponding positions one by one according to the numberings of the elastic rods, numberings of joints and the construction sequence, and connecting the elastic rods at the joints positions by the joints, and gradually forming the spatial curved surface as the elastic rods are connected together one by one; in response that all the elastic rods are connected, the interwoven elastic rods reach a stress balance due to an interaction of the rods and become a gridshell structure of the spatial curved surface.

9. The construction method of the self-forming weaving structure system by elastic rod for construction of spatial curved surface according to claim 8, characterized in that:
the planning organization scheme in step 2 further includes a circuit design of a light-emitting device, wherein then in step 4, according to the circuit design, the light-emitting device is placed inside the main frame of the structure, and constructing the light-emitting device and the elastic rod simultaneously;
the light-emitting device includes a circuit controller and a light-emitting strip, wherein the light-emitting strip is connected to a transformer through a wire, and the light-emitting strip controls series connection and parallel connection of the light-emitting strips through the circuit controller to obtain different spatial lighting effects;
after step 4, attaching an enclosure structure onto the elastic rods to cover the inner space of the gridshell structure.

10. The construction method of the self-forming weaving structure system by elastic rod for construction of spatial curved surface according to claim 8, characterized in that:
the algorithm in step 1 includes a form generation algorithm and a stress analysis algorithm;
the form generation algorithm is as follows:
firstly, taking the spatial curved surface generated by the three-dimensional modeling software as an original input; generating, by the algorithm, a triangular mesh grid as uniform as possible on the spatial curved surface according to a given length of each edge of the mesh of the spatial curved surface after importing the spatial curved surface into the form generation program, wherein the grid is an original grid, and then connecting midpoints of each edge of the original grid to generate a new grid; in the new grid, all joints are joints with two intersecting rods, and there is no case that three or more rods intersecting, so as to reduce the construction difficulty; optimizing and transforming the new grid into a continuous curve, and generating a tubular members along the continuous curves as a axis, wherein the tubular structure is the self-forming weaving structure model consistent with the original curved surface form; in the model, the information of the length of the rod and the joint position are all correspond to the actual construction situation;
the stress analysis algorithm is as follows:
a basic stress unit is two thin rods connected by a hinge joint; the hinge joint are integrated with a spring for bending resistance; in response that the spring is compressed, the two rods approach to each other, and the angle between the two rods becomes smaller; in response that the spring is extended, the two rods move away from each other and the angle between the two rods becomes larger, so as to simulate elastic bending resistance of the rod; in response that the rod system is imported into a stress analysis program, the bending rod is divided into a set of rod units, and each unit is connected sequentially to form a chain of elastic rods; setting parameters of the spring in the stress analysis program according to the mechanical properties of material; adding external forces of the rod units and anchoring points of the rod units in the stress analysis program according to a structural design; performing calculation and iterating step by step after all the spring parameters, the external forces of the rod units and the anchoring points of the rod units are inputted into the stress analysis program, that is, calculating, by the stress analysis algorithm, a final reached balance state, i.e., a state of simulating the real situation obtained by the stress analysis program, after mutual force transmission by the rod units through the spring.
